(19) United States
(12) Patent Application Publication
(10) Pub. No.: US 2014/0236824 A1
(43) Pub. Date: Aug. 21, 2014

(54) METHOD TO DETECT AND CONTROL UNWANTED OUTGOING PAYMENT SERVICES USAGE IN SMART DEVICES

(71) Applicant: TELEFONICA, S.A., Madrid (ES)

(72) Inventors: Antonio Manuel Amaya Calvo, Madrid (ES); Enrique Diaz Fernandez, Madrid (ES); Alejandro Becerra González, Madrid (ES)

(21) Appl. No.: 14/110,270

(22) PCT Filed: Sep. 27, 2012
(86) PCT No.: PCT/EP2012/069029

§ 371 Date: Oct. 7, 2013

(30) Foreign Application Priority Data
Oct. 4, 2011 (ES) P201131600

(51) Int. Cl. G06Q 20/32; G06Q 20/40

(52) U.S. Cl. CPC G06Q 20/322; G06Q 20/40
USPC 705/44

(57) ABSTRACT

In the method of the invention an outgoing payment service is requested by an application running on a smart device and it comprises the development of specific software residing in said smart device and the mobile network to control and detect if said outgoing payment service has the corresponding authorization and can be executed or if it is part of a fraud.

### FIELD OF THE ART

The present invention generally relates to a method to detect and control unwanted outgoing payment services usage in smart devices, wherein an outgoing payment service is requested by an application running on a smart device, and more particularly to a method that comprises the development of specific software residing in said smart device and in the mobile network to control and detect if said outgoing payment service has the corresponding authorization and can be executed or if it is part of a fraud.

### PRIOR STATE OF THE ART

Some years ago dial-up was the usual way for residential users to connect to Internet. On those times, for a computer to connect to Internet it had to have a modem, and dial a special number, provided by the user's ISP. Usually upon connection the ISP did some kind of authentication and authorization of the user, to assure that only paying users could access the network.

On those times a new computer threat was born. Called generically ‘dialler’, it was a kind of program that offered free dial-up access to Internet. Or even to some particular pages on the Internet (generally porn) that were only available if the access was realized by the special dialler program. And in fact the network access was free. No authentication, or authorization required, and no subscription to any ISP.

What wasn't free was the phone number the dialler program dialled. Thus the dialler programs were a kind of scam: network access was free, but the phone call, instead of being a local (or even flat rate) number as the ones generally provided by legal ISPs were premium numbers, with a high price per minute.

That threat went away at the same time broadband access (xDSL, cable, etc.) became mainstream for residential users and dial-up became a marginal way to access the network. With this change, it became less and less common for computers to have any kind of phone modem, and thus the illegal business dried up.

But times are changing again. While the mainstream computing platform until now has been some kind of Personal Computer, currently there's a rise of smartphones as a computing platform. BusinessInsider [1], predicts than on 2011 there will be around 400 million of smartphones globally, the same number than of personal computers.

Smartphones have some similarities and differences with traditional personal computers.

Personal computers are generally open platforms. There's no restriction imposed by the hardware or the operating system on what applications or kind of applications can be installed. Also applications usually work on an all or nothing way: they either cannot be run at all or they run with the same permissions that the user running them has.

On the other hand, smartphones are closed platforms. Usually the device builder, the OS maker, or both, impose restrictions on what applications or kind of applications can be installed. Moreover, most devices applications run on some kind of sandbox, where the application interaction with the physical device is restricted and controlled.

The next table summarizes the restrictions imposed on applications by the main smartphone OS.

| | | | | | Personal | |
|---|---|---|---|---|---|---|
| | | Isolated | | Distribution | information | |
| System | Sandbox | applications | Permission | model | access | Background |
| iPhone | Yes, API | Yes | Global | Centralized | Yes, global | No (yes on |
| | enforces | | | | | 4th) |
| Symbian | Yes? | Yes? | By application. | Distributed | Yes, granted | Yes |
| | | | Granted by the user or | | by application | |
| | | | by the device maker. | | | |
| Android | Yes, API | Yes | By application. | Centralized, | Yes, granted | Yes |
| | and OS | | Granted on the | but with a | by application | |
| | enforced | | installation. | distributed | | |
| | | | | option | | |
| Windows | No | No | Global | Centralized, | Yes, global | Yes |
| Mobile | | | | but with a | | |
| (6.x) | | | | distributed | | |
| | | | | option | | |
| Windows | Unknown | Unknown | By application. | Unknown yet | Yes. Probably | Yes? |
| Phone 7 | yet | yet | Planned to be granted | | by application | |
| | | | on installation and on | | (not defined | |
| | | | runtime | | yet) | |

And, of course, one big difference between a traditional personal computer and a smartphone is that a smartphone is, first and foremost, a phone. And as such, it has, obviously, the possibility to perform phone calls, the same way than a traditional personal computer which has a modem and is attached to a land line can do.

And, in the same way than when computers used to have modems attached to land lines diallers were born, a new generation of diallers, designed to work on smartphones, is being born. And just as the last time around, when diallers usually depended on deceiving users to get installed and run, this time diallers also depend on deception to get installed and avoid OS protections.

Thus, for example, a dialler was detected not long ago [2] for the Android OS. Android, as can be seen on the summary table, has pretty strong OS protections. In fact, according to Android developers:

“The security and privacy of our users' data is of primary importance to the Android Open Source Project. We are dedicated to building and maintaining one of the most secure mobile platforms available while still fulfilling our goal of opening the mobile device space to innovation and competition.

The Android Platform provides a rich security model that allows developers to request the capabilities, or access, needed by their application and to define new capabilities that other applications can request. The Android user can choose to grant or deny an application's request for certain capabilities on the handset.”

But even with the restrictions and protections, the program was able to send premium SMS, just deceiving the users to grant the adequate permissions to the application. And, again according to the OS developers, that is the intended functionality of the protection model:

“Our application permissions model protects against this type of threat. When installing an application, users see a screen that explains clearly what information and system resources the application has permission to access, such as a user's phone number or sending an SMS. Users must explicitly approve this access in order to continue with the installation, and they may uninstall applications at any time. We consistently advise users to only install apps they trust. In particular, users should exercise caution when installing applications outside of Android Market.”

And this time around the problem isn't just going to go away. Since one of the reasons of the success of smartphones is, precisely, that they are phones, it isn't reasonable to assume that they'll lose the ‘phone’ part just as traditional personal computers lost their modems once dial up was superseded by broadband.

### PROBLEMS WITH EXISTING SOLUTIONS

Other difference smartphones have with traditional personal computers is that while on computers there's a vibrant industry that just build tools to fight against any kind of malware, currently there's almost no smartphone malware protection tools. On some smartphones it's even by design. Thus, not so long ago, when the first worms for iPhones were detected, it was also reported than iPhone architecture was ‘less than optimal’ for the implementation of any kind of antivirus software [3].

To be able to successfully implement some kind of antivirus software on a smartphone, the OS should allow:
Background applications to run and consume CPU cycles.
Interaction between applications. Antivirus applications must be able to analyze what other applications are doing while they're doing it.

Some smartphones OS don't allow the first point, ironically for ‘security reasons’. And practically all of them forbid the second point, also because of security reasons.

And last but not least, smartphones have another difference with traditional computers: they're designed to run usually on battery power. And their battery life time depends on how busy is the CPU. So traditional antivirus approaches, where the antivirus is constantly running and monitoring the system, would mean a much degraded battery life time.

### DESCRIPTION OF THE INVENTION

It is necessary to offer an alternative to the state of the art which covers the gaps found therein, particularly related to the lack of proposals which really allows decreasing or even eliminating the fraud generated by third party applications making use of the phone features (paid services) of an smartphone.

To that end, the present invention provides a method to detect and control unwanted outgoing payment services in smart devices, wherein an outgoing payment service is requested by an application running on a smart device.

On contrary to the known proposals, the method of the invention, in a characteristic manner it comprises
attaching in a unforgeable way, an application developer, a first identifier number to said application;
installing said application in said smart device;
detecting, said smart device, that said application is requesting to access an outgoing payment service;
generating, said smart device, a second identifier number from parameters obtained from said application;
comparing, said smart device, said first and second identifier numbers and depending on the result of said comparison:
   allowing, said smart device, said request to access said outgoing payment service by generating an outgoing signal including said first identifier number and sending said outgoing signal to a network, or
   rejecting, said smart device, said request to access said outgoing payment service.
detecting, said network, the existence of said first identifier number on the access request from the smartphone; and
deciding, said network, to allow or reject the connection based on the previously expressed preferences of a smart device user or of said network.

Other embodiments of the method of the first aspect of the invention are described according to appended claims 3 to 21, and in a subsequent section related to the detailed description of several embodiments.

### DETAILED DESCRIPTION OF SEVERAL EMBODIMENTS

The proposed invention is based on the development of specific hardware and software residing on the end user terminals (smartphones) and the mobile network to allow the detection and control of unwanted outgoing paid services (phone calls and SMS).

Control is implemented based on the following broad points:
Applications that request access to the phone paid services (calls, SMS, etc.) will have to be signed. Note that actually this is a current requisite on most modern mobile operating systems, and as thus application signing, although it's a pre-requisite for the invention isn't a part of it.
Applications developers that want to access the phone paid services (calls, SMS, etc.) have to request an identifier number (IMAI from now on) for their applications.
IMAI numbers will be included, on the application executable. The application executable must be signed with the developer certificate. Note that this signature requirement exists actually on practically all smartphones OSs
Smartphone OS will apply the access restrictions, as usual, but only applications that have an IMAI might be granted access to the mobile network. For every outgoing call, message or any other kind of paid service, the IMAI of the originating application must be included on the call information passed to the network
Network will keep a list of per-subscriber or per-network approved IMAIs. Additional restrictions (such as an approved number call list) might be applied to some IMAIs.

The proposed system has the following modules:

On the application development environment:
IMAI Generator.

On the smartphone, running as part of the mobile phone operating system:
Local Policy Enforcer (LPE).
Feedback Module.

On the mobile operator cellular network
Network Policy Enforcer (NPE).
Network Policy Configurator (NPC)

IMAI Generator

The function of this module is generating IMAI numbers, when a developer requests them. The development process for any application is as follows:
The application is developed following current methods.
Once the application is developed, the application developer uses an IMAI Generator module to generate a valid number.
The IMAI number generated is attached to the application. The way this number is attached to the application depends on the actual operating system that the application will run in. Some valid methods are:

If the operating system allows the use of application metadata (such as application name, version, etc.) then the IMAI number will be included as metadata.

If the operating system permits the use of additional data (non executable data) then the IMAI number will be included as additional data.

If the operating system permits (or demands) the use of manifest files, then the IMAI number will be included as part of the manifest file

The application, including the IMAI number, will be signed using current signing methods and a developer certificate. Developers' certificates will be generated by the operating system builder, as currently.

An IMAI number is an 8 byte value. As an input to generate a valid IMAI number, the IMAI Generator requires the Distinguished Name (DN) of the developer's certificate and the Distinguished Name of the Certificate Authority that signs the developer certificate (or alternatively, since both data can be obtained directly from the developer's signing certificate, it can receive the signing certificate as input). The process the IMAI Generator uses to generate a valid IMAI number is as follows:

1. Generate a 4 byte random number. This number is called RN1.

2. Calculate DN-RN1 by appending RN1 to the Distinguished Name (DN) of the developer, and the Distinguished Name (DN) of the certificate authority as included in the developer's signing certificate.

3. Using a one way function, such as SHA-1 or a similar function (let's call H( ) to this generic one-way function), generate H(DN-RN1).

4. Truncate H(DN-RN1) to the first (higher value) 4 bytes. The value thus generated will be the 4 highest value bytes of the IMAI number.

5. RN1 will be the lowest value 4 bytes value of the IMAI number.

Local Policy Enforcer

This module will be part of the Operating System (OS) of the smartphones. It has the following function:

When an application requests access to a paid network service (calls, SMS, etc.), verifying that the application has an IMAI attached. If the application does not have an IMAI number, the request is denied. Otherwise, if the application has an IMAI number, the LPE must verify that it is a valid IMAI number. To check if an IMAI is valid, all the following procedure must be executed:

a. Verify that the application is correctly signed. If it isn't signed, deny the request.

b. Calculate DN-RN2 by appending the Distinguished Name (DN) of the subject and the Distinguished Name of the signer of the application signing certificate with the 4 lowest bytes of the IMAI number included in the application.

c. Verify that the following condition is true: H(DN-RN2)=highest 4 bytes of the IMAI number of the application. If the condition isn't true, deny the request.

If the IMAI number is valid (as checked by the previously stated procedure), then append the IMAI number to the outgoing call data and forward it to the cellular network.

The purpose of the procedure described at steps a, b and c is to avoid the possibility of a fraudulent developer using an IMAI number generated by a legal developer to try to get access to the network. Let's assume an IMAI number I, generated with the procedure described above. Furthermore, let's assume that the DN of the application developer is DNA and the DN of the CA that signs the application's developer certificate is DNCA:

Thus I=High4 (H(DNA+DNCA+RN1))+RN1 where High4 is a function that returns the first 4 bytes of a string of bytes, and + is a byte concatenation function.

If a fraudulent developer wants to get access to his application by reusing the permissions of the legal developer application he can try to include ‘I’ as the IMAI in his application. But he will have to sign the application with his own certificate, which will include DNA′ (the fraudulent developer Distinguished Name) and DNCA′ (the CA that signs the fraudulent developer certificate). Note that DNCA′ can be the same that DNCA (both certificates can be signed by the same CA) but necessarily DNA will be different from DNA′.

The Local Policy Enforcer will calculate High4(H(DNA′+DNCA′+RN1)) and will compare it with the highest 4 bytes of I, which are High4(H(DNA+DNCA+RN1)). Since DNA is different from DNA′, the hashes will be different and thus the comparison will fail, resulting in the Local Policy Enforcer denying access to the network to the application.

Network Policy Enforcer

This module will be included as part of the mobile operator cellular network (VLR and HLR) and performs the following procedure:

For each call processed:

1. If the call doesn't have an IMAI number as part of the signalling data, assume it's generated from a non compliant terminal and let it pass as they do currently.

2. If the call includes an IMAI number, check if the IMAI is on the approved list for the subscriber that is generating the call. The NPE will have one or more approved lists, including:
A general approved list of IMAIs that are enabled for all subscribers, and all destination numbers. In this list is included, for example, the calling applications for the terminal builders.
A subscriber unlimited approved list of IMAIs that are enabled for a specific subscriber and all destination numbers.
A subscriber limited approved list, of IMAIs that are enabled for a specific subscriber and a concrete list of destination numbers.

3. If the calling IMAI (and destination number, if it's on a limited list) are on an approved list, let the call proceed as they do currently.

4. If the calling IMAI isn't on an approved list, the NPE may drop the call without further action, or it may generate an approval request. Both modes of operation are correct. In any case, both if an approval request is generated and if it isn't, the call will be terminated.

5. An approval request is a signalling message sent to the call emitting terminal, and if generated it must be captured by the Feedback Module running on the terminal, or be ignored by the terminal.

Feedback Module

This module will be included on the Operating System (OS) of the smartphones, and has the following function:

1. Capture approval requests generated by the NPE. Note that approval requests must be captured by the Feedback Module and must not be allowed to be captured by any other application running on the phone. If the phone doesn't have a Feedback Module running, the approval requests must be ignored.

2. When an approval request is captured, the Feedback Module will show a screen to the phone user, informing him that an outgoing call made by application ‘X’ to the number ‘N’ has been rejected by the network, and allowing him the option to add the application/called number to his approved list.

3. The user can choose approving the application only for the number it was trying to call, or for all the numbers.

4. If the user chooses to approve the application (add the application/called number to his list), then the Feedback module will generate an ‘Approval Authorization’ and send it to the Network Policy Configurator. The Approval Authorization will contain the following data:
IMAI of the application to be authorized.
Destination number that will be allowed for the application, or ‘0’ if the application has unrestricted access to the network
IMSI of the subscriber that is approving the application
A Hash Message Authentication Code (HMAC) of the previous data, using the subscriber key from his SIM as authentication key.

Network Policy Configurator

The Network Policy Configurator module will reside on the mobile operator cellular network, and has the following function:

1. Capture the Approval Authorizations, as described on the previous sections.

2. Verify the HMAC with the data included in the Authorization. If the HMAC verification fails, do nothing and finish.

3. If the HMAC verification succeeds, add the IMAI number, and destination number if specified to the subscriber (obtained from the IMSI in the Approval Authorization) corresponding approved list.

### ADVANTAGES OF THE INVENTION

The invention will decrease significantly or even eliminate the fraud generated by third party applications making use of the phone features (paid services) of a smartphone. Note that while the cellular operator is completely innocent in this kind of fraud, cellular operator will be the one that the scammed user will reclaim to. And it will be the cellular operator, also, the one that might lose a client because of the fraud.

Since the enforcement point is on the network, it won't consume resources on the smartphones, and it can't be evaded by software running on the phone. It will be impossible for a fraudulent application to know beforehand if it's on the list of approved applications or not, and to modify the approved calling lists.

With the method described the application developers won't see their bureaucratic charge increased, since they can generate and administer their own IMAI numbers. At the same time, IMAI number will be associated to their identity, protecting both themselves and the users against fraudulent usage. Although it's recommended for developers to generate a different IMAI number for each application the system doesn't actually require or enforce it.

Introducing an additional value (IMAI number) instead of just relaying on application signatures has two advantages:
Permission granularity, giving developers an easy way to specify which of their applications have access to the network paid services.
It allows enforcement to run at the network level (instead of the mobile phone level), while altering the protocol in the minimum possible way. Checking application signatures on the network wouldn't be practical, secure or even viable on most cases.

A person skilled in the art could introduce changes and modifications in the embodiments described without departing from the scope of the invention as it is defined in the attached claims.

### ACRONYMS

ADSL Asymmetric Digital Subscriber Line

API Application Programming Interface

CA Certificate Authority

CPU Central Processing Unit

HLR Home Location Register

HMAC Hash-based Message Authentication Code

IMSI International Mobile Subscriber Identity

ISP Internet Service Provider

OS Operating System

SHA Secure Hash Algorithm

SIM Subscriber Identity module

SMS Short Message Service

UMTS Universal Mobile Telecommunication System

VLR Visitor Location Register

### REFERENCES

[1] Business Insider: http://www.businessinsider.com/chart-of-the-day-pcs-market-share-microsoft-vs-the-rest-2010-6
[2] Dialler detected on the wild: http://news.cnet.com/8301-27080_{—}3-20013222-245.html
[3] No antivirus for iPhones: http://www.theregister.co.uk/2009/11/25/iphone_anti_malware/

1. A method to detect and control unwanted outgoing payment services usage in smart devices, wherein an outgoing payment service is requested by an application running on a smart device, the method comprises
attaching, an application developer, a first identifier number to said application;
installing said application in said smart device;
detecting, said smart device, that said application is requesting to access an outgoing payment service;
generating, said smart device, a second identifier number from parameters obtained from said application;
comparing, said smart device, said first and second identifier numbers and depending on the result of said comparison:
allowing, said smart device, said request to access said outgoing payment service by generating an outgoing signal including said first identifier number and sending said outgoing signal to a network, or
rejecting, said smart device, said request to access said outgoing payment service.

2. A method as per claim 1, further comprising:
detecting, said network, the existence of said first identifier number on an access request from said smart device; and
deciding, said network, to allow or reject a connection of said smart device to said network based on the previously expressed preferences of a smart device user or said network.

3. A method as per claim 1, wherein said network is a cellular network.

4. A method as per claim 1, comprising attaching said first identifier number to an application executable of said application in the form of metadata, additional data or as part of a manifest file.

5. A method as per claim 1, comprising signing together said application with said first identifier number by means of signing methods and a developer's certificate.

6. A method as per claim 5, comprising generating said first identifier number by making use of a distinguished name of said developer's certificate and a distinguished name of the certificate authority that signs said developer's certificate.

7. A method as per claim 1, wherein said first identifier number is an eight byte number.

8. A method as per claim 7, comprising signing together said application with said first identifier number by means of signing methods and a developer's certificate; generating said first identifier number by making use of a distinguished name of said developer's certificate and a distinguished name of the certificate authority that signs said developer's certificate; the method further comprising generating said first identifier number as follows:
generating a four byte random number;
grouping said distinguished name of said developer's certificate, said distinguished name of the certificate authority that signs said developer's certificate and said four byte random number in a group number;
using a one way function with said group number as an input to obtain a resulting number;
truncating said resulting number to the first, or more significant, four bytes; and
appending to said first four bytes said four byte random number as the four less significant bytes.

9. A method as per claim 8, wherein said one way function is a Hash function.

10. A method as per claim 1, comprising rejecting, said smart device, said request to access said outgoing payment service if said application does not have said first identifier number attached.

11. A method as per claim 5, comprising rejecting, said smart device, said request to access said outgoing payment service if said application with said first identifier number is not correctly signed.

12. A method as per claim 7, comprising signing together said application with said first identifier number by means of signing methods and a developer's certificate; generating said first identifier number by making use of a distinguished name of said developer's certificate and a distinguished name of the certificate authority that signs said developer's certificate; the method further comprising performing said generation of said second identifier number by grouping said distinguished name of said developer's certificate, said distinguished name of the certificate authority that signs said developer's certificate and the lowest four bytes of said first identifier number.

13. A method as per claim 12 comprising performing said comparison between said first and second identifier numbers as follows:
using said second identifier number as an input of said one way function;
truncating the result of said one way function to the first, or more significant, four bytes; and
comparing said four bytes with the first, or more significant, four bytes of said first identifier number.

14. A method as per claim 1, comprising performing said outgoing payment service, once that said request to access said outgoing payment service has been allowed, if said first identifier number included in said outgoing signal belongs to an approved list residing in said network.

15. A method as per claim 1, comprising
dropping said outgoing payment service; or
generating and sending and approval request to said smart device;
once that said request to access said outgoing payment service has been allowed, if said first identifier number included in said outgoing signal does not belong to an approved list residing in said network.

16. A method as per claim 14, wherein said list comprises at least one of: a general approved list of first identifier numbers for all subscribers of said network and all destination numbers, a subscriber unlimited approved list of first identifier numbers for a specific subscriber of said network and all destination numbers or a subscriber limited list of first identifier number for a specific subscriber of said network and a specific list of destination numbers.

17. A method as per claim 16, comprising
dropping said outgoing payment service; or
generating and sending and approval request to said smart device;
once that said request to access said outgoing payment service has been allowed, if said first identifier number included in said outgoing signal does not belong to an approved list residing in said network; the method further comprising capturing, said smart device, said approval request and, by displaying means of said smart device, demanding a subscriber of said smart device authorization for an application to perform said outgoing payment service.

18. A method as per claim 17, comprising
rejecting said outgoing payment service if said subscriber denies said authorization; or
generating an approval authorization and sending said approval authorization to said network if said subscriber approves said authorization.

19. A method as per claim 18, wherein said approval authorization comprises as data the following parameters: said first identifier number, a destination number allowed for said application or a parameter indicating that said application has unrestricted access to all destination numbers of said network, an International Mobile Subscriber Identity of said subscriber of said smart device and a Hash Message Authentication Code, or HMAC, containing said parameters.

20. A method as per claim 18, comprising capturing, said network, said approval authorization.

21. A method as per claim 20, comprising verifying said HMAC with said parameters of said approval authorization and
rejecting said outgoing payment service if said verification fails; or
adding said first identifier number to said list if said verification succeeds allowing performing said outgoing payment service.
